(19) United States
(12) Patent Application Publication
(10) Pub. No.: US 2024/0285043 A1
(43) Pub. Date: Aug. 29, 2024

(54) CONNECTOR AND TIMEPIECE

(71) Applicant: CASIO COMPUTER CO., LTD., Shibuya-ku, Tokyo (JP)

(72) Inventor: Yoshiki NAKATSUKA, Higashiyamato-shi, Tokyo (JP)

(73) Assignee: CASIO COMPUTER CO., LTD., Shibuya-ku, Tokyo (JP)

(21) Appl. No.: 18/693,662

(22) PCT Filed: Aug. 5, 2022
(86) PCT No.: PCT/JP2022/030086

§ 371 Date: Mar. 20, 2024

(30) Foreign Application Priority Data
Sep. 21, 2021 (JP) 2021-153223

(51) Int. Cl. A44C 5/14; G04B 37/16

(52) U.S. Cl. CPC A44C 5/147; G04B 37/16

(57) ABSTRACT

A connector includes a slide section whose one side is provided with a catching and releasing section which is engageable with and disengageable from a catching section formed in a first member, and an operation section which includes a head section and an engaging section fixed in an engaging target section formed in the catching and releasing section of the slide section, is attached to a second member, and releases the catching and releasing section from engaging with the catching section.

### TECHNICAL FIELD

The present invention relates to a connector that is used for accessories such as wristwatches, and a timepiece provided with the connector.

### BACKGROUND ART

For example, a wristwatch is known which has a structure where a band is connected to a wristwatch case by a connector including a cylindrical member which is attached to an end of the band, a pair of slide pieces provided in end portions of the cylindrical member in a manner to be retractable, and an operation section provided on at least one of the slide pieces, as shown in Patent Document 1.

### PRIOR ART DOCUMENT

### Patent Document

Patent Document 1: JP 2018-038470

This type of wristwatch is structured such that a coil spring is arranged in the cylindrical member of the connector attached to the end of the band, and the pair of slide pieces is pushed outward by the spring force of the coil spring and inserted into attachment holes in a band attachment section of the wristwatch case, whereby the band is connected to the wristwatch case.

Also, this type of wristwatch is structured such that the operation section is operated against the spring force of the coil spring so as to slide the corresponding slide piece and pull this slide piece out of the attachment hole in the band attachment section of the wristwatch case, whereby the band is disconnected form the wristwatch case.

### SUMMARY OF INVENTION

### Problem to be Solved by the Invention

In this type of wristwatch, the operation section is required to be arranged on the side corresponding to the back surface of the wristwatch case because a design where the operation section is arranged and exposed on the side corresponding to the front surface of the wristwatch case is not preferable. As a result of this structure, this wristwatch has a problem in that, when the wristwatch case is to be used by being worn on an arm, the operation section touches the arm, which is uncomfortable.

An object of the present invention is to provide an easily detachable connector with a good wearing feeling, and a timepiece provided with the connector.

### Means for Solving the Problem

The present invention is a connector characterized by comprising: a catching and releasing section which is engageable with and disengageable from a catching section formed in a first member; and an operation section which includes a first portion and a second portion provided in the catching and releasing section, is attached to a second member, and releases the catching and releasing section from engaging with the catching section.

### Effect of the Invention

According to the present invention, an easily detachable product with a good wearing feeling can be provided.

### BRIEF DESCRIPTION OF DRAWINGS

FIG. 1 is an enlarged front view showing an embodiment where the present invention has been applied in a wristwatch;

FIG. 2 is an enlarged cross-sectional view showing a main portion of the wristwatch taken along the A-A arrow view in FIG. 1;

FIG. 3 is an enlarged perspective view of an exterior member for a wristwatch case shown in FIG. 1;

FIG. 4 is an enlarged cross-sectional view of a band attachment section of the wristwatch case taken along the B-B arrow view in FIG. 1;

FIG. 5 is an enlarged perspective view of the main portion including the band attachment section in FIG. 2, in which an slide groove of a catching section in a band connection piece attached to an end of a watch band is shown;

FIG. 6 is an enlarged perspective view of the band connection piece shown in FIG. 5;

FIG. 7 is an enlarged cross-sectional view of a main portion of the band attachment section shown in FIG. 4, in which operation sections have been pressed from both sides so as to release the locking of the band connection piece by an engaging and disengaging section;

FIG. 8 is an enlarged cross-sectional view showing a state where the band connection piece has been detached from a connector shown in FIG. 4; and

FIG. 9 is an enlarged cross-sectional view showing a state where the band connection piece has been detached from the connector shown in FIG. 7.

### DESCRIPTION OF EMBODIMENTS

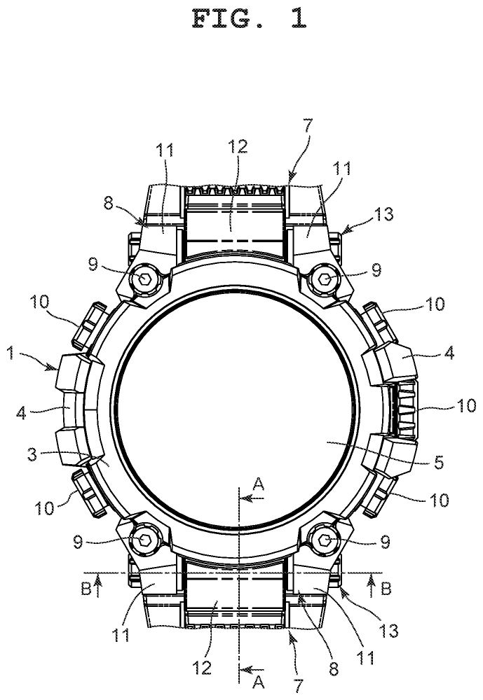

An embodiment where the present invention has been applied in a wristwatch will hereinafter be described with reference to FIG. 1 to FIG. 9.

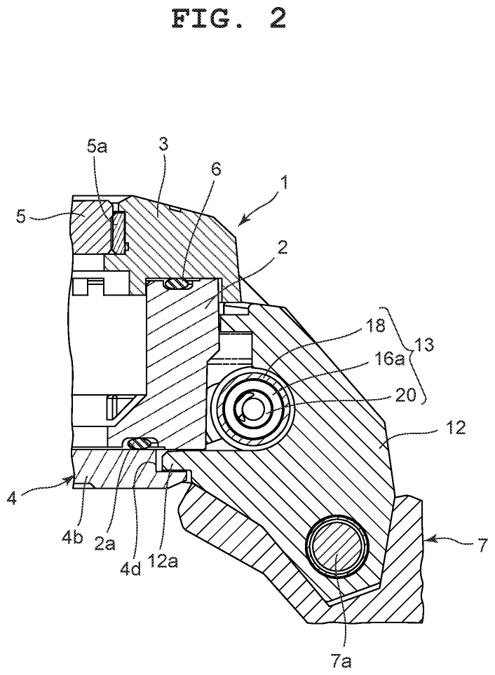

This wristwatch includes a wristwatch case 1, as shown in FIG. 1 and FIG. 2. The wristwatch case 1 includes a case main body 2, an upper case 3, and an exterior member 4. The case main body 2 is made of metal or a hard synthetic resin, and has a substantially ring shape.

The upper case 3 is arranged on the upper part of the case main body 2, as shown in FIG. 1 and FIG. 2. This upper case 3 is made of metal or a hard synthetic resin, and has a substantially ring shape. To this upper case 3, a watch glass 5 is attached via a packing 5a. Also, in an area between the undersurface of the upper case 3 and the upper surface of the case main body 2, a first waterproof packing 6 is provided.

The exterior member 4 is made of a material whose rigidity has been increased by carbon fiber or glass fiber being mixed into a highly rigid polyamide resin, as shown in FIG. 1 to FIG. 3. This exterior member 4 includes bezel sections 4a which are arranged on outer circumferential portions of the case main body 2, a back cover section 4b which is arranged on the undersurface of the case main body 2, and band attachment sections 8 to which watch bands 7 are attached, and these sections are integrally formed.

As a result, the wristwatch case 1 is structured such that the bezel sections 4a of the exterior member 4 are arranged on the outer circumferential portions of the case main body 2, the back cover section 4b of the exterior member 4 is arranged on the undersurface of the case main body 2 via a second waterproof packing 2a, and then the upper case 3 is arranged on the upper surface of the case main body 2 and attached by a plurality of screws 9, as shown in FIG. 1 to FIG. 3.

Also, the wristwatch case 1 is structured such that, when the upper case 3 is to be arranged on the upper surface of the case main body 2, the first waterproof packing 6 is interposed therebetween, attachment sections (not shown) of the upper case 3 are arranged in this state in attachment recess sections 4c of the exterior member 4, and the upper case 3 is attached to the exterior member 4 by the plurality of screws 9, whereby the case main body 2 is held and fixed between the upper case 3 and the exterior member 4, as shown in FIG. 1 to FIG. 3.

On the other hand, in the wristwatch case 1, a timepiece module (not shown) is provided. Also, in side portions of the wristwatch case 1 on the two o'clock side, the three o'clock side, the four o'clock side, the eight o'clock side, and the ten o'clock side, switch sections 10 are provided, as shown in FIG. 1. In addition, in side portions of the wristwatch case 1 on the twelve o'clock side and the six o'clock side, the band attachment sections 8 are provided which are second members and to which the watch bands 7 are attached, as shown in FIG. 1 to FIG. 4.

These band attachment sections 8 include pairs of attachment projection sections 11 provided projecting on twelve o'clock side portions and six o'clock side portions of the bezel sections 4a of the exterior member 4 of the wristwatch case 1, as shown in FIG. 1 to FIG. 4. In an area between each pair of attachment projection sections 11, a band connection piece 12 which is a first member connected to an end of the corresponding watch band 7 is arranged.

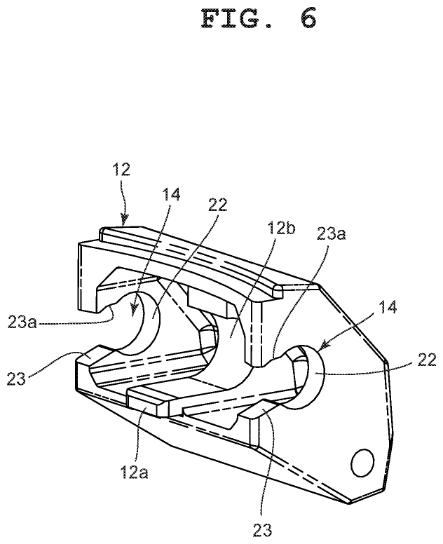

This band connection piece 12 is connected to the end of the watch band 7 by a connecting pin 7a, as shown in FIG. 1 and FIG. 2. In addition, this band connection piece 12 is arranged and attached between the pair of attachment projection sections 11 of the corresponding band attachment section 8 by a connector 13. Also, this band connection piece 12 is made of a sintered metal acquired by metal powder being sintered, and has a substantially box shape whose inside is hollow, as shown in FIG. 6.

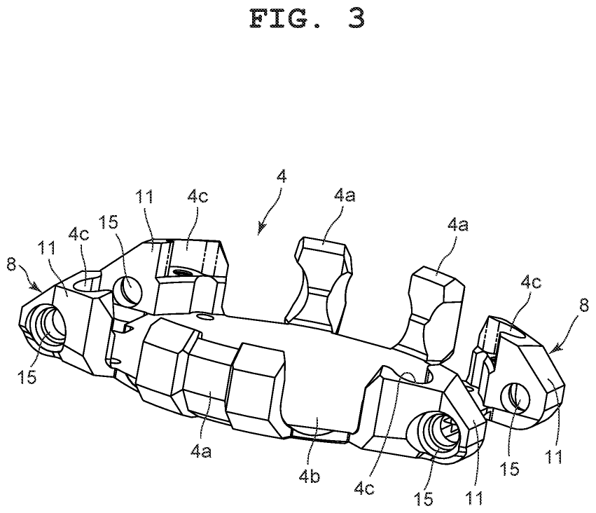

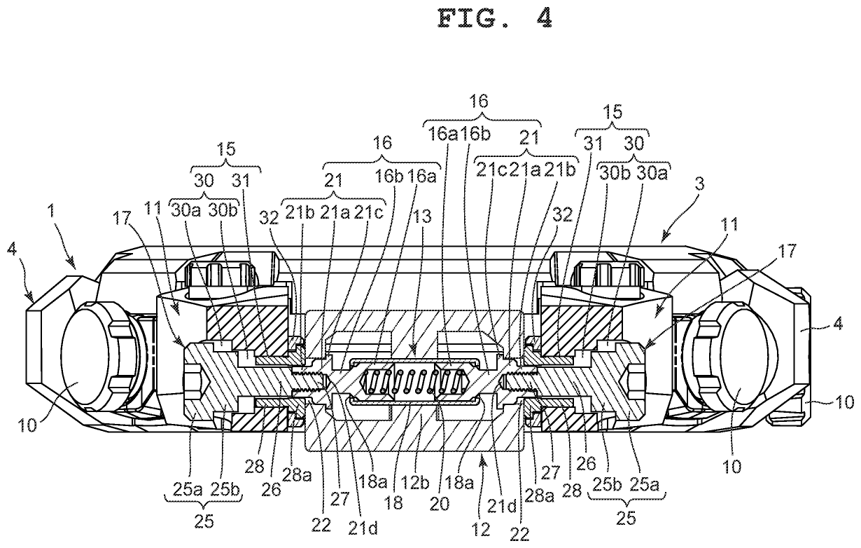

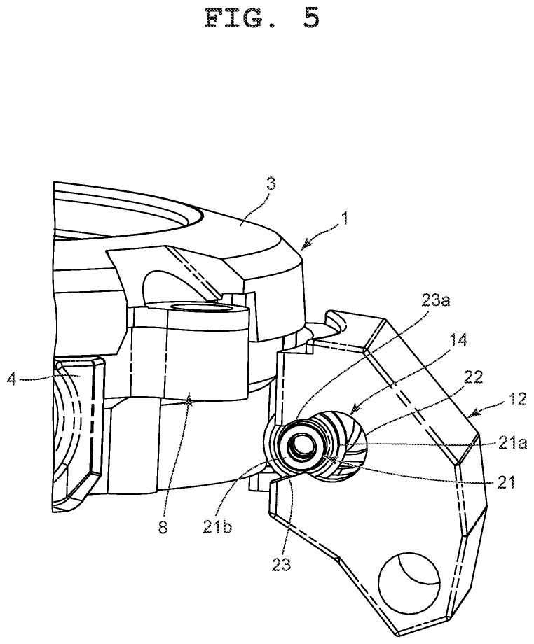

The band connection piece 12 arranged between the pair of attachment projection sections 11 is open toward the outer circumferential surface side of the wristwatch case 1, as shown in FIG. 2, FIG. 5, and FIG. 6. In side portions of the band connection piece 12 in a width direction of the watch band 7 perpendicular to a longitudinal direction thereof, catching sections 14 are formed coaxially with each other. Accordingly, in the pair of attachment projection sections 11, attachment holes 15 are formed coaxially with the catching sections 14 of the band connection piece 12, as shown in FIG. 3 and FIG. 4.

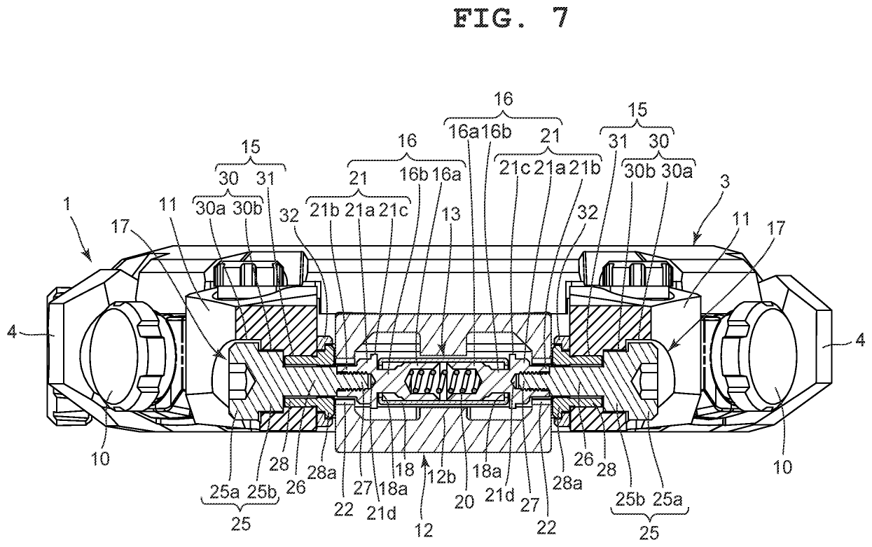

The connector 13 includes a pair of slide sections 16 which is detachably attached to the sides of the band connection piece 12, a pair of operation sections 17 which is slidably attached to the pair of attachment projection sections 11 of the band attachment section 8 so as to slide the pair of slide sections 16, a metal cylindrical member 18 into which opposing end portions of the pair of slide sections 16 are inserted, and a coil spring 20 that serves as an energizing member which is arranged in the cylindrical member 18 and forces the pair of slide sections 16 outward from inside the cylindrical member 18, as shown in FIG. 4 and FIG. 7.

The pair of slide sections 16 are made of a metal such as titanium alloy. Each slide section 16 includes an engaging and disengaging section 21 which is a catching and releasing section, a small-diameter shaft 16b, and an insertion section 16a, and is structured such that the insertion section 16a is slidably arranged in the cylindrical member 18, as shown in FIG. 4, and FIG. 7 to FIG. 9. That is, the pair of slide sections 16 is structured such that the insertion sections 16a are slidably inserted into the cylindrical member 18 in a manner not to be slipped out from inside the cylindrical member 18 by slipping stopper sections 18a on the ends of the cylindrical member 18.

Each small-diameter shaft 16b of the pair of slide sections 16 is formed such that its outer diameter is shorter than the outer diameter of each insertion section 16a and substantially equal to the inner diameter of each slipping stopper section 18a provided on the ends of the cylindrical member 18, as shown in FIG. 4, and FIG. 7 to FIG. 9. As a result, the pair of slide sections 16 is structured such that, when the engaging and disengaging sections 21 are pushed against the spring force of the coil spring 20, the small-diameter shafts 16b are pressed into the cylindrical member 18 through the slipping stopper sections 18a on the ends of the cylindrical member 18.

The engaging and disengaging sections 21 of the pair of slide sections 16 are structured to be engageably and disengageably caught in the catching sections 14 in the sides of the band connection piece 12 by being slid thereinto, and separated from the band connection piece 12 by being released from the catching sections 14, as shown in FIG. 4 and FIG. 7.

Each catching section 14 in the sides of the band connection piece 12 includes a fitting hole 22 and a slide groove 23, as shown in FIG. 6. The slide groove 23 is a cutout portion and formed extending from the inner circumferential surface of the fitting hole 22 to an end portion of the band connection piece 12 on the open side. This slide groove 23 is formed such that its groove width is smaller than the inner diameter of the fitting hole 22.

On the other hand, each engaging and disengaging section 21 includes a fitting shaft 21a which is a fitting section having a large diameter and fitted into the corresponding fitting hole 22 of the band connection piece 12, and a slide shaft 21b which is a sliding section having a small diameter and moves through the corresponding slide groove 23, as shown in FIG. 4 and FIG. 7. This engaging and disengaging section 21 is structured such that the fitting shaft 21a and the slide shaft 21b are coaxially formed, and one of these shafts is arranged in the fitting hole 22. That is, the slide shaft 21b of this engaging and disengaging section 21 is provided on the outer end of the fitting shaft 21a which is positioned on the outer side of the band connection piece 12.

This slide shaft 21b is formed such that its outer diameter is shorter than the outer diameter of the fitting shaft 21a, as shown in FIG. 4 and FIG. 7. In addition, this slide shaft 21b is structured such that, when the fitting shaft 21a is moved in an axial direction so as to be separated from the fitting hole 22 of the band connection piece 12, this slide shaft 21b can be arranged in the fitting hole 22, inserted into the slide groove 23 of the band connection piece 12, and moved through the slide groove 23.

As a result, the engaging and disengaging sections 21 are structured such that, when the fitting shafts 21a are fitted into the fitting holes 22 of the band connection piece 12, the slide sections 16 lock the band connection piece 12, as shown in FIG. 4 and FIG. 7. Also, these engaging and disengaging sections 21 are structured such that, when the fitting shafts 21a are moved in the axial directions and separated from the fitting holes 22 of the band connection piece 12 and the slide shafts 21b are arranged in the fitting holes 22, the locking of the band connection piece 12 by the fitting shafts 21a are released.

Moreover, these engaging and disengaging sections 21 are structured such that, when the locking of the band connection piece 12 by the slide sections 16 is released, the slide shafts 21b are inserted into the slide grooves 23 of the band connection piece 12 in a manner to be able to pass through the slide grooves 23, as shown in FIG. 4 and FIG. 7. That is, these engaging and disengaging sections 21 are structured such that, when the slide shafts 21b are inserted into the slide grooves 23 of the band connection piece 12 and pass through the slide groove 23, these slide shafts 21b are separated from the band connection piece 12, whereby the band connection piece 12 is detached from the band attachment section 8 of the wristwatch case 1 together with the watch band 7.

Furthermore, these engaging and disengaging sections 21 include stopper sections 21c which prevent each fitting shaft 21a from slipping out toward the corresponding operation section 17 side when the fitting shafts 21a are fitted into the fitting holes 22 of the band connection piece 12, as shown in FIG. 4 and FIG. 7. Each stopper section 21c is formed such that its outer diameter is longer than the outer diameter of the corresponding fitting shaft 21a, and provided on the inner end surface of this fitting shaft 21a on the cylindrical member 18 side.

As a result, the stopper sections 21c are structured such that, when the fitting shafts 21a are fitted into the fitting holes 22 of the band connection piece 12, these stopper sections 21c come in contact with the rims of the fitting holes 22 of the band connection piece 12 so that the engaging and disengaging sections 21 do not slip out from inside the band connection piece 12, as shown in FIG. 4 and FIG. 7.

The slide groove 23 of each catching section 14 of the band connection piece 12, which is provided extending from the inner circumferential surface of the fitting hole 22 to the outer end of the band connection piece 12 on the opening side, is formed such that its groove width is substantially equal to the outer diameter of the small-diameter slide shaft 21b of the corresponding engaging and disengaging section 21, as shown in FIG. 5 and FIG. 6. As a result, the engaging and disengaging sections 21 are structured such that, when the fitting shafts 21a are separated from the fitting holes 22 of the band connection piece 12 and the slide shafts 21b are arranged in the fitting holes 22, these slide shafts 21b pass through the slide grooves 23 of the band connection piece 12 so as to be shifted out of the band connection piece 12.

Also, in each slide groove 23 of the band connection piece 12, a slide regulation section 23a is formed which temporarily restricts the slide shaft 21b of the corresponding engaging and disengaging section 21 from passing through the slide groove 23, as shown in FIG. 5 and FIG. 6. This slide regulation section 23a changes the movement direction of the slide shaft 21b of the engaging and disengaging section 21 to an obliquely downward direction when the slide shaft 21b is moving in a substantially horizontal direction along the slide groove 23 of the band connection piece 12 so as to prevent the slide shaft 21b from being rapidly shifted out of the slide groove 23 and thereby prevent the watch band 7 from slipping off the wristwatch case 1.

The coil spring 20, which energizes the pair of slide sections 16, is arranged in the cylindrical member 18 and forces the insertion sections 16a of the pair of slide sections 16 in directions in which the insertion sections 16a are pressed toward the outside of the cylindrical member 18, as shown in FIG. 4 and FIG. 7. More specifically, the coil spring 20 is structured such that its ends are inserted into the cylindrical portions of the insertion sections 16a of the pair of slide sections 16 and force the pair of slide sections 16 by its spring force in the directions in which the insertion sections 16a are pressed toward the outside of the cylindrical member 18.

Also, each small-diameter shaft 16b of the pair of slide sections 16 is formed between the insertion section 16a of the corresponding slide section 16 and the fitting shaft 21a of the corresponding engaging and disengaging section 21, as shown in FIG. 4 and FIG. 7. This small-diameter shaft 16b is structured to move the fitting shaft 21a in an axial direction so as to separate it from the inside of the corresponding fitting hole 22 of the band connection piece 12. More specifically, this small-diameter shaft 16b is formed such that its outer diameter is equal to the inner diameter of each slipping stopper section 18a of the cylindrical member 18 and its axial length is substantially equal to that of the fitting shaft 21a of the engaging and disengaging section 21.

As a result, the small-diameter shafts 16b of the pair of slide sections 16 are structured such that, when the engaging and disengaging sections 21 of the slide sections 16 are pressed from the outside against the spring force of the coil spring 20, these small-diameter shafts 16b are inserted into the cylindrical member 18, as shown in FIG. 4 and FIG. 7. Consequently, the slide sections 16 are structured such that, when the small-diameter shafts 16b are inserted into the cylindrical member 18, the fitting shafts 21a of the engaging and disengaging sections 21 are moved in the axial directions and shifted out of the fitting holes 22 of the band connection piece 12, and the slide shafts 21b of the engaging and disengaging sections 21 are arranged in the fitting holes 22.

On the other hand, the pair of operation sections 17, which is used to slide the pair of slide sections 16 against the spring force of the coil spring 20, is made of a metal such as stainless steel, as shown in FIG. 4 and FIG. 7. Each operation section 17 has a structure where a stepped head section 25, a shaft section 26 (first portion), and a thread section 27 (second portion) have been coaxially formed next to one another.

The stepped head section 25 includes a large-diameter head section 25a and a small-diameter head section 25b, as shown in FIG. 4 and FIG. 7. Also, the shaft section 26 is formed such that its outer diameter is shorter than the outer diameter of the small-diameter head section 25b and equal to the outer diameter of the slide shaft 21b of the corresponding slide section 16. The thread section 27, which is detachably attached to the slide section 16, is formed such that its outer diameter is shorter than that of the shaft section 26.

The pair of operation sections 17 is structured to be slidably inserted into the attachment holes 15 in the pair of attachment projection sections 11 of the corresponding band attachment section 8 of the wristwatch case 1 with them being attached to the slide sections 16, as shown in FIG. 4 and FIG. 7. Also, each attachment hole 15 includes a stepped hole 30 into which the stepped head section 25 of the corresponding operation section 17 is inserted, and a shaft hole 31 into which a pipe section 28 where the shaft section 26 of the operation section 17 is inserted is fitted.

In the stepped hole 30, a large-diameter hole 30a into which the large-diameter head section 25a of the stepped head section 25 of the operation section 17 is retractably inserted and a small-diameter hole 30b into which the small-diameter head section 25b thereof is retractably inserted are coaxially formed next to each other, as shown in FIG. 4 and FIG. 7. The pipe section 28, into which the shaft section 26 of the corresponding operation section 17 and the slide shaft 21b of the corresponding slide section 16 are inserted, is made of a metal such as stainless steel and fitted into the shaft hole 31 formed in the corresponding attachment projection section 11 of the band attachment section 8.

This pipe section 28 is formed such that its inner diameter is equal to the outer diameter of the shaft section 26 of the operation section 17 and the outer diameter of the slide shaft 21b of the slide section 16, and its axial length is longer than that of the shaft hole 31 of the attachment projection section 11, as shown in FIG. 4 and FIG. 7. As a result, the pipe section 28 is structured to protrude from the shaft hole 31 of the attachment projection section 11 toward the band connection piece 12 when inserted into the shaft hole 31. On this protruding end portion, a stepped flange section 28a is formed.

This stepped flange section 28a of the pipe section 28 is structured such that its outer circumference portion has a stepped shape and its end surface in an axial direction comes in contact with the outer end surface of the band connection piece 12, as shown in FIG. 4 and FIG. 7. Also, this stepped flange section 28a is structured such that a space is formed between the outer surface of the band connection piece 12 and the inner surface of the attachment projection section 11 of the band attachment section 8.

On the outer circumferential portion of this stepped flange section 28a, a decorative member 32 having a ring shape is provided, as shown in FIG. 4, and FIG. 7 to FIG. 9. This decorative member 32 is made of a metal such as aluminum. The surface of this decorative member 32 is subjected to alumite treatment so as to decorate it.

The shaft section 26 of the operation section 17 is formed such that its axial length is longer than that of the shaft hole 31 of the attachment hole 15 and substantially equal to the axial length of the pipe section 28, as shown in FIG. 4 and FIG. 7. That is, the shaft section 26 is structured such that, when the stepped head section 25 of the operation section 17 is pressed into the stepped hole 30 of the attachment hole 15 in the attachment projection section 11, this shaft section 26 arranged in the pipe section 28 presses the thread section 27 of the operation section 17 in the pipe section 28 toward the inside of the band connection piece 12.

The operation section 17 is structured such that the thread section 27 is screwed into a screw hole 21d formed in the engaging and disengaging section 21 of the slide section 16 and extending in an axial direction from an end of the engaging and disengaging section 21, whereby this operation section 17 is detachably attached to the slide section 16, as shown in FIG. 4, and FIG. 7 to FIG. 9. The screw hole 21d in the engaging and disengaging section 21 of the slide section 16 is formed such that its axial length is longer than that of the thread section 27 of the operation section 17 and substantially equal to the total axial length of the fitting shaft 21a and the slide shaft 21b.

On the other hand, on a lower middle portion of the band connection piece 12 on the open side, a fixing projection 12a is formed, as shown in FIG. 2 and FIG. 6. This fixing projection 12a, which fixes the band connection piece 12 to the wristwatch case 1, is structured to be arranged on an undersurface portion of the case main body 2 located between the attachment projection sections 11 of the pair of the band attachment sections 8, and then arranged in a fixing recess section 4d formed in the back cover section 4b of the exterior member 4.

As a result, this fixing projection 12a is structured to fix the band connection piece 12 to the wristwatch case 1 by being arranged in the fixing recess section 4d of the back cover section 4b and held between the fixing recess section 4d and the undersurface of the case main body 2, as shown in FIG. 2 and FIG. 6. In a middle portion of the inner surface of the band connection piece 12, a holding section 12b which holds the cylindrical member 18 is formed in a manner to be curved in a semicircular arc shape.

Next, a procedure for attaching the watch bands 7 to the wristwatch case 1 is described. First, each connector 13 is attached to the corresponding band attachment section 8 of the wristwatch case 1. Here, before this attachment, the coil spring 20 is arranged in the cylindrical member 18, and the pair of slide sections 16 is attached to the inner sides of the end portions of the cylindrical member 18.

More specifically, the pair of slide sections 16 is attached to the inner sides of the end portions of the cylindrical member 18 with the coil spring 20 being arranged in the cylindrical member 18, and then the slipping stopper sections 18a are formed on the ends of the cylindrical member 18 by swaging. As a result, the insertion sections 16a of the pair of slide sections 16 are fixed to the inner sides of the end portions of the cylindrical member 18 in a manner not to slip out by the spring force of the coil spring 20 in the cylindrical member 18.

In this state, the engaging and disengaging sections 21 and the small-diameter shafts 16b of the pair of slide sections 16 are protruding from the ends of the cylindrical member 18 by being pressed outward. Then, the cylindrical member 18 provided with the pair of slide sections 16 is arrange between the pair of attachment projection sections 11 of the band attachment section 8 of the wristwatch case 1 and attached to the band attachment section 8 by use of the pair of operation sections 17.

Here, the shaft sections 26 and the thread sections 27 of the pair of operation sections 17 are inserted into the pipe sections 28 in the shaft holes 31 of the attachment holes 15 in the pair of attachment projection sections 11 through the stepped holes 30 of the attachment holes 15, whereby the stepped head sections 25 of the pair of operation sections 17 correspond to the stepped holes 30. Also, here, the slide shafts 21b of the engaging and disengaging sections 21 of the pair of slide sections 16 are inserted into the pipe sections 28 of the pair of attachment projection sections 11.

As a result, the shaft sections 26 of the operation sections 17 and the slide shafts 21b of the slide sections 16 are coaxially arranged in the pipe sections 28, and the thread sections 27 of the operation sections 17 and the screw holes 21d of the engaging and disengaging sections 21 of the slide sections 16 are coaxially arranged in the pipe sections 28. In this state, the slide sections 16 are fixed by a tool or the like, and the stepped head sections 25 of the operation sections 17 are rotated. As a result, the thread sections 27 of the operation sections 17 are screwed into and tightened in the screw holes 21d of the slide sections 16.

In this state, the large-diameter head sections 25a of the stepped head sections 25 of the pair of operation sections 17 are protruding from the attachment holes 15 through the large-diameter holes 30a of the stepped holes 30 of the attachment holes 15 in the pair of attachment projection sections 11. As a result of this procedure, the pair of operation sections 17 is attached to the pair of slide sections 16 and the pair of attachment projection sections 11 of the band attachment section 8.

That is, the pair of operation sections 17 is attached to the pair of attachment projection sections 11 while being slidably arranged in the attachment holes 15 of the pair of attachment projection sections 11, the pair of slide sections 16 and the cylindrical member 18 are attached to the pair of attachment projection sections 11 while being arranged between the pair of attachment projection sections 11 by the pair of operation sections 17. As a result of this procedure, each connector 13 is attached to the corresponding band attachment section 8 of the wristwatch case 1.

Next, a procedure for attaching each watch band 7 to the corresponding band attachment section 8 of the wristwatch case 1 by use of the corresponding connector 13 is described.

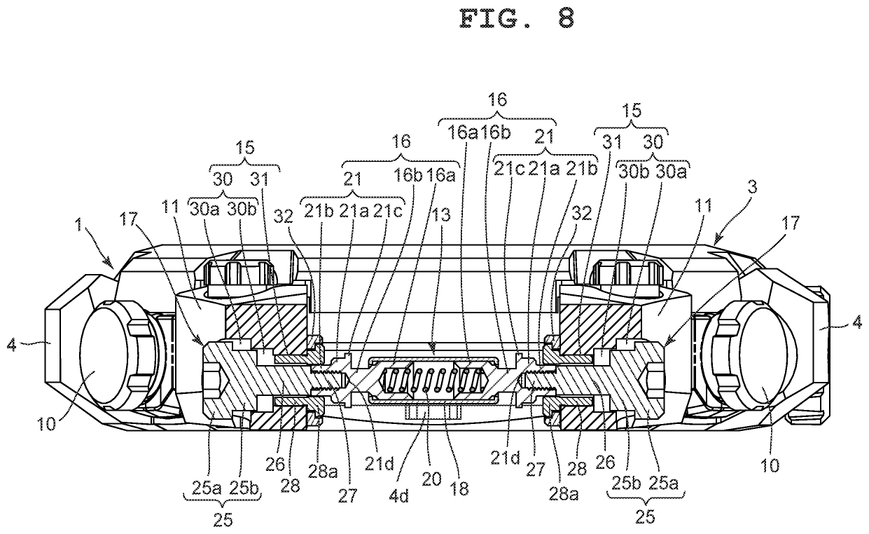

First, in a state shown in FIG. 8, the stepped head sections 25 of the pair of operation sections 17 are pressed from both sides in the axial directions against the spring force of the coil spring 20. As a result, the engaging and disengaging sections 21 with the attached thread sections 27 of the pair of operation sections 17 are slid toward the ends of the cylindrical member 18, and the small-diameter shafts 16b are pressed into the cylindrical member 18.

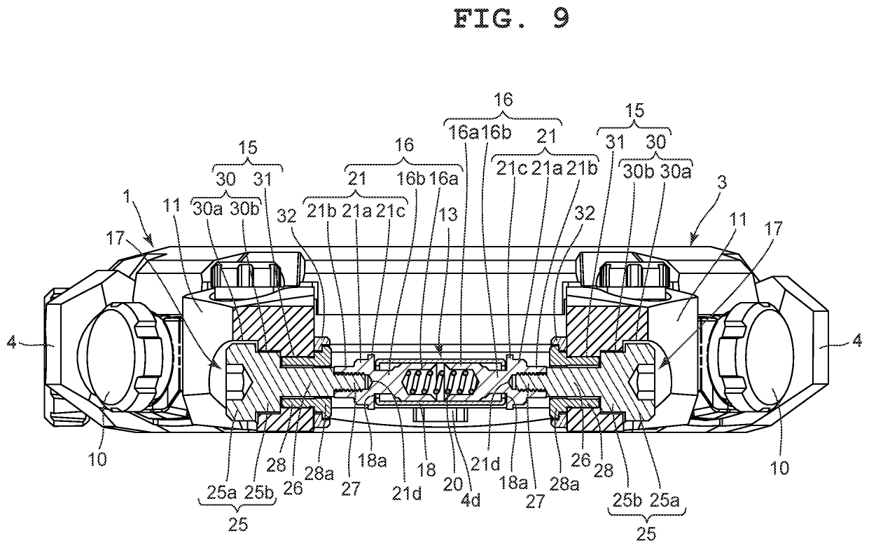

Here, the slide shafts 21b of the engaging and disengaging sections 21 are pressed out of the pipe sections 28 in the attachment holes 15 in the attachment projection sections 11 of the band attachment section 8, and the fitting shafts 21a of the engaging and disengaging sections 21 are arranged on the ends of the cylindrical member 18, as shown in FIG. 9. As a result, in an area between the pair of attachment projection sections 11 of the band attachment section 8, the band connection piece 12 of the watch band 7 can be attached to the connector 13 having the pair of operation sections 17 attached thereto.

Accordingly, the band connection piece 12 is attached to the connector 13. In this attachment, first, the band connection piece 12 is attached to the end portion of the watch band 7 by the connecting pin 7a. In this state, the band connection piece 12 is arranged between the pair of attachment projection sections 11 of the band attachment section 8 such that the opening side of the band connection piece 12 is positioned corresponding to the connector 13. In addition, the slide grooves 23 of the catching sections 14 in the sides of the band connection piece 12 are positioned corresponding to the slide shafts 21b of the pair of engaging and disengaging sections 21 of the connector 13.

Then, the slide shafts 21b of the engaging and disengaging sections 21 are inserted into the slide grooves 23 of the catching sections 14 of the band connection piece 12, and moved into the fitting holes 22 of the catching sections 14 through these slide grooves 23, as shown in FIG. 5. In this state, the external force which is being exerted on the stepped head sections 25 of the pair of operation sections 17 is released. As a result, the insertion sections 16a of the pair of slide sections 16 are forced toward the outside of the cylindrical member 18 by the spring force of the coil spring 20, as shown in FIG. 4.

Here, the small-diameter shafts 16b are pushed out of the cylindrical member 18, the fitting shafts 21a of the engaging and disengaging sections 21 are fitted into the fitting holes 22 of the catching sections 14 of the band connection piece 12, and the stopper sections 21c of the engaging and disengaging sections 21 come in contact with the rims of the fitting holes 22 of the catching sections 14. As a result, the band connection piece 12 is connected to the connector 13 and whereby they are locked together.

In addition, the slide shafts 21b of the engaging and disengaging sections 21 are pushed out of the fitting holes 22 of the catching sections 14 and inserted into the pipe sections 28 fitted into the shaft holes 31 of the attachment projection sections 11. As a result, the pair of operation sections 17 is pressed outward through the attachment holes 15 of the pair of attachment projection sections 11. In this state, the large-diameter head sections 25a of the stepped head sections 25 of the pair of operation sections 17 have been pushed out of the large-diameter holes 30a of the stepped holes 30 of the attachment holes 15 in the pair of attachment projection sections 11 in a manner to protrude outside the attachment holes 15.

Here, the fixing projection 12a formed on the band connection piece 12 is arranged in the fixing recess section 4d formed in the back cover section 4b of the exterior member 4 and, in this state, held between the undersurface of the case main body 2 and the back cover section 4b. As a result, the band connection piece 12 is fixed to the wristwatch case 1. In addition, the cylindrical member 18 arranged in the band connection piece 12 is held in the holding section 12b formed in the middle portion of the inner surface of the band connection piece 12.

As a result, the band connection piece 12 is connected to the connector 13 and whereby they are locked together. Accordingly, the band connection piece 12 is attached to the pair of attachment projection sections 11 of the band attachment section 8 by the connector 13, and the watch band 7 is attached to the band attachment section 8 of the wristwatch case 1 by the band connection piece 12.

Next, a procedure for detaching each watch band 7 from the corresponding band attachment section 8 of the wristwatch case 1 is described. In each detachment, the pair of operation sections 17 protruding outward from the attachment holes 15 in the pair of attachment projection sections 11 of the band attachment section 8 is pressed from both sides in the axial directions against the spring force of the coil spring 20, as shown in FIG. 4. As a result, the pair of slide sections 16 is slid in the directions to approach each other, as shown in FIG. 7.

Here, the engaging and disengaging sections 21 are moved toward the cylindrical member 18 by the thread sections 27 of the operation sections 17, and the small-diameter shafts 16b are pressed into the cylindrical member 18. Accordingly, the fitting shafts 21a of the engaging and disengaging sections 21 are separated from the fitting holes 22 of the catching sections 14 of the band connection piece 12, and pressed toward the inner side of the band connection piece 12. In addition, the slide shafts 21b of the engaging and disengaging sections 21 are moved into the fitting holes 22 of the catching sections 14.

As a result, the locking of the band connection piece 12 by the fitting shafts 21a of the engaging and disengaging sections 21 is released. In this state, the slide shafts 21b of the engaging and disengaging sections 21 moved into the fitting holes 22 of the catching sections 14 formed in the band connection piece 12 are inserted into the slide grooves 23 of the catching sections 14 by the band connection piece 12 being moved. Then, the slide shafts 21b pass through the slide grooves 23 by being moved obliquely downward along the slide grooves 23, as shown in FIG. 5.

When passing through the slide grooves 23 of the band connection piece 12 as described above, the slide shafts 21b come in contact with the slide regulation sections 23a formed on the slide grooves 23, whereby the sliding of the slide shafts 21b is regulated. That is, when the slide shafts 21b are passing through the slide grooves 23, the movement directions of the slide shafts 21b moving in substantially horizontal directions are changed so that the slide shafts 21b are moved obliquely downward.

As a result of this structure, the slide shafts 21b of the engaging and disengaging sections 21 are not rapidly shifted out of the slide grooves 23 of the band connection piece 12, which prevents each watch band 7 from rapidly slipping off the wristwatch case 1. Accordingly, the watch bands 7 can be favorably detached from the band attachment sections 8 of the wristwatch case 1.

As such, each connector 13 of this wristwatch includes the engaging and disengaging sections 21 which are catching and releasing sections and can engage with the catching sections 14 formed in the corresponding band connection piece 12 that is a first member, and the operation sections 17 each of which includes the shaft section 26 that is a first portion and the thread section 27 that is a second portion provided in the corresponding engaging and disengaging section 21, and which are attached to the corresponding band attachment section 8 that is a second member and release the catching sections 14 from engaging with the engaging and disengaging sections 21. As a result of this structure, the easily detachable connectors with a good wearing feeling can be provided.

More specifically, in each connector 13 of this wristwatch, the engaging and disengaging sections 21 are operated by the operation sections 17, whereby the catching sections 14 of the band connection piece 12 are released from engaging with the engaging and disengaging sections 21, and the band connection piece 12 is detached from the engaging and disengaging sections 21. As a result of this structure, the detachment work can be easily performed. Also, the operation sections 17 are slidably attached to the pair of attachment projection sections 11 of each band attachment section 8. As a result of this structure, the operation sections 17 do not become encumbrances, and the wristwatch case 1 can be attached to an arm by the watch bands 7 with a good wearing feeling.

Also, in the case of this connector 13 of the wristwatch, each catching section 14 of the band connection piece 12 includes the fitting hole 22 and the slide groove 23 which has a groove width shorter than the inner diameter of the fitting hole 22 and extends from the inner circumferential surface of the fitting hole 22 to the outer end of the band connection piece 12, and each engaging and disengaging section 21 includes the fitting shaft 21a which is a fitting section that is fitted into the fitting hole 22 and the slide shaft 21b which is a sliding section that is inserted into and pass through the slide groove 23 when the fitting shaft 21a is separated from the fitting hole 22. As a result of this structure, the band connection piece 12 can be disengageably engaged with the engaging and disengaging section 21 or the engaging and disengaging section 21 can be disengaged from the band connection piece 12.

That is, in the case of this connector 13 of the wristwatch, the fitting shafts 21a of the engaging and disengaging sections 21 are fitted into the fitting holes 22 of the catching sections 14 of the band connection piece 12, whereby the band connection piece 12 can be locked by the engaging and disengaging sections 21. Also, by the fitting shafts 21a of the engaging and disengaging sections 21 being separated from the fitting holes 22 of the catching sections 14 and the slide shafts 21b being inserted into and passing through the slide grooves 23, the locking of the band connection piece 12 by the engaging and disengaging sections 21 are released, whereby the band connection piece 12 can be easily and favorably separated and detached from the engaging and disengaging sections 21.

Moreover, in this connector 13 of the wristwatch, each engaging and disengaging section 21 includes the stopper section 21c which prevents the fitting shaft 21a from slipping out toward the corresponding operation section 17 side when the fitting shaft 21a is fitted into the corresponding fitting hole 22 of the band connection piece 12. By the presence of these stopper sections 21c, the fitting shafts 21a of the engaging and disengaging sections 21 can be fitted into the fitting holes 22 of the band connection piece 12 with pressure. As a result of this structure, each band connection piece 12 can be unfailingly locked by the fitting shafts 21a of the engaging and disengaging sections 21.

That is, in the case of this connector 13 of the wristwatch, when the fitting shafts 21a of the engaging and disengaging sections 21 are fitted into the fitting holes 22 of the band connection piece 12, the stopper sections 21c come in contact with the rims of the fitting holes 22, whereby the fitting shafts 21a can be unfailingly fitted into the fitting holes 22 with pressure and the band connection piece 12 can be unfailingly locked by the fitting shafts 21a.

Furthermore, in the case of this connector 13 of the wristwatch, since each slide groove 23 of the band connection piece 12 is provided with the slide regulation section 23a which regulates the sliding of the slide shaft 21b of the corresponding engaging and disengaging section 21, the slide shaft 21b passing through the corresponding slide groove 23 can be temporarily restricted from passing through the slide groove 23 by the slide regulation section 23a so as not to be rapidly shifted out of the slide groove 23, whereby the corresponding watch band 7 can be prevented from rapidly slipping off the wristwatch case 1.

That is, in the case of this connector 13 of the wristwatch, when moving to pass through the slide groove 23, the slide shaft 21b comes in contact with the slide regulation section 23a formed on the slide groove 23, which can change the movement direction of the slide shaft 21b. As a result, the slide shaft 21b does not rapidly slip out of the slide groove 23.

Still further, this connector 13 of the wristwatch includes the coil spring 20 which is an energizing member that forces the engaging and disengaging sections 21 in the directions to be away from each other and, by the spring force of this coil spring 20, the fitting shafts 21a of the engaging and disengaging sections 21 can be invariably fitted into the fitting holes 22 of the catching sections 14 of the band connection piece 12 so as to lock the band connection piece 12.

Yet still further, in the case of this connector 13 of the wristwatch, the fitting shafts 21a of the engaging and disengaging sections 21 can be separated from the fitting holes 22 of the catching sections 14 of the band connection piece 12 by the operation sections 17 being pressed against the spring force of the coil spring 20, whereby the locking of the band connection piece 12 can be released and the band connection piece 12 can be easily detached from the connector 13.

Yet still further, this connector 13 of the wristwatch includes the cylindrical member 18 in which the insertion sections 16a on the end portions of the engaging and disengaging sections 21 and the coil spring 20 serving as an energizing member are arranged. As a result of this structure, the pair of slide sections 16 can be slidably connected by the cylindrical member 18, and the insertion sections 16a of the slide sections 16 arranged in the end portions of the cylindrical member 18 can be forced in the directions to be pushed outward from the cylindrical member 18 by the spring force of the coil spring 20 arranged in the cylindrical member 18.

Yet still further, in this connector 13 of the wristwatch, the small-diameter shafts 16b, which are necessary for separating the fitting shafts 21a of the engaging and disengaging sections 21 from the fitting holes 22 of the catching sections 14, are formed between each engaging and disengaging section 21 and the corresponding insertion section 16a. As a result of this structure, when the engaging and disengaging sections 21 are pressed against the spring force of the coil spring 20, the small-diameter shafts 16b can be inserted into the cylindrical member 18, whereby the fitting shafts 21a can be reliably and favorably separated from the insides of the fitting holes 22.

Yet still further, in the case of this connector 13 of the wristwatch, each operation section 17 is detachably provided on the axial center portion of the corresponding engaging and disengaging section 21. Accordingly, by the operation sections 17, the engaging and disengaging sections 21 can be attached to the pair of attachment projection sections 11 of the band attachment section 8 of the wristwatch case 1. In addition, by being detached from the engaging and disengaging sections 21, the operation sections 17 can be easily detached from the slide sections 16.

Yet still further, in the case of this connector 13 of the wristwatch, in the pair of attachment projection sections 11 of the band attachment section 8 which is a second member, the pipe sections 28 are provided into which the shaft sections 26 that are first portions of the operation sections 17 are slidably inserted and also the slide shafts 21b of the engaging and disengaging sections 21 are inserted such that they can be pulled out toward the band connection piece 12 side. As a result of this structure, in a state where the fitting shafts 21a of the engaging and disengaging sections 21 have been fitted into the fitting holes 22 of the band connection piece 12 so as to lock the band connection piece 12, the shaft sections 26 of the operation sections 17 and the slide shafts 21b of the engaging and disengaging sections 21 are positioned in the pipe sections 28, whereby the band connection piece 12 can be reliably and favorably fixed in a stable state.

Yet still further, in the case of this connector 13 of the wristwatch, on the band connection piece 12 that is a first member, the fixing projection 12a is formed which is arranged in the fixing recess section 4d in the band attachment section 8 that is a second member so as to fix the band connection piece 12 to the band attachment section 8. As a result of this structure, the fixing projection 12a of the band connection piece 12 can be arranged in the fixing recess section 4d of the band attachment section 8 when the band connection piece 12 is arranged between the pair of attachment projection sections 11 and locked by the fitting shafts 21a of the engaging and disengaging sections 21, whereby the band connection piece 12 can be reliably and favorably fixed to the band attachment section 8.

In the above-described embodiment, the pipe sections 28 are fitted into the shaft holes 31 of the attachment holes 15 formed in the pair of attachment projection section 11 of each band attachment section 8 of the wristwatch case 1. However, in the present invention, the pipe sections 28 are not necessarily required to be provided, and a structure may be adopted in which the shaft sections 26 of the operation sections 17 and the slide shafts 21b of the slide sections 16 are inserted into the shaft holes 31.

Also, in the above-described embodiment, the first members are the band connection pieces 12 and the second members are the band attachment sections 8. However, the present invention is not limited thereto. For example, the first members may be the band attachment sections 8 and the second members may be the band connection pieces 12.

Moreover, in the above-mentioned embodiment, the present invention has been applied in a wristwatch. However, the present invention is not necessarily required to be applied in a wristwatch and, for example, can be widely applied to accessories such as belts for arm-wearable devices that are used by being worn on an arm, bracelets, and clothes.

### INDUSTRIAL APPLICABILITY

According to the present invention, an easily detachable product with a good wearing feeling can be provided.

### DESCRIPTION OF REFERENCE NUMERALS

1 wristwatch case
2 case main body
2a second waterproof packing
3 upper case
4 exterior member
4a bezel section
4b back cover section
4c attachment recess section
4d fixing recess section
5 watch glass
6 first waterproof packing
7 watch band
8 band attachment section
10 switch section
11 attachment projection section
12 band connection piece
12a fixing projection
12b holding section
13 connector
14 catching section
15 attachment hole
16 slide section
17 operation section
18 cylindrical member
18a slipping stopper section
20 coil spring
21 engaging and disengaging section
21a fitting shaft
21b slide shaft
21c stopper section
21d screw hole
22 fitting hole
23 slide groove
23a slide regulation section
25 stepped head section
25a large-diameter head section
25b small-diameter head section
26 shaft section
27 thread section
28 pipe section
30 stepped hole
30a large-diameter hole
30b small-diameter hole
31 shaft hole
32 decorative member

1-12. (canceled)

13. A connector comprising:
a slide section whose one side is provided with a catching and releasing section which is engageable with and disengageable from a catching section formed in a first member; and
an operation section which includes a head section and an engaging section fixed in an engaging target section formed in the catching and releasing section of the slide section, is attached to a second member, and releases the catching and releasing section from engaging with the catching section.

14. The connector according to claim 13, wherein the catching section of the first member includes a fitting hole and a slide groove which has a groove width shorter than an inner diameter of the fitting hole and extends from an inner circumferential surface of the fitting hole to an outer end of the first member, and
wherein the catching and releasing section includes a fitting section which has a large diameter and is fitted into the fitting hole, and a sliding section which has a small diameter and is capable of being inserted into and passing through the slide groove when the fitting section is separated from the fitting hole.

15. The connector according to claim 14, wherein the catching and releasing section includes a stopper section which prevents the fitting section from slipping out toward the operation section side when the fitting section is fitted into the fitting hole.

16. The connector according to claim 14, wherein the slide groove is provided with a slide regulation section which regulates sliding of the sliding section.

17. The connector according to claim 13, wherein the catching and releasing section is a pair of catching and releasing sections, and includes an energizing member which forces the catching and releasing sections in directions to be away from each other.

18. The connector according to claim 17, further comprising:
a cylindrical member in which insertion sections provided on end portions of the catching and releasing sections and the energizing member are arranged.

19. The connector according to claim 18, wherein small-diameter shafts for separating fitting sections of the catching and releasing sections from fitting holes of catching sections are formed between each catching and releasing section and the corresponding insertion section.

20. The connector according to claim 13, wherein the operation section is detachably provided on an axial center portion of the catching and releasing section.

21. The connector according to claim 13, wherein the second member includes a pipe section into which the first portion of the operation section is slidably inserted and the sliding section of the catching and releasing section is inserted such that the sliding section can be pulled out toward the first member side.

22. The connector according to claim 13, wherein the first member is provided with a fixing projection which is arranged in a fixing recess section formed in the second member so as to fix the first member to the second member.

23. A timepiece comprising the connector according to claim 13.

24. The timepiece according to claim 23, wherein the first member is one of a band attachment section provided on a timepiece case and an end portion of a band that is attached to the band attachment section, and the second member is an other one of the band attachment section and the end portion of the band.
